(19) United States
(12) Patent Application Publication
(10) Pub. No.: US 2015/0151378 A1
(43) Pub. Date: Jun. 4, 2015

(54) WELDING METHOD, WELDING NOZZLE AND WELDING DEVICE

(71) Applicant: OSAKA UNIVERSITY, Suita-shi, Osaka (JP)

(72) Inventors: Hidetoshi Fujii, Suita-shi (JP); Yoshiaki Morisada, Suita-shi (JP)

(73) Assignee: OSAKA UNIVERSITY, Suita-shi, Osaka (JP)

(21) Appl. No.: 14/400,034

(22) PCT Filed: Apr. 11, 2013
(86) PCT No.: PCT/JP2013/060965

§ 371 Date: Jan. 20, 2015

(30) Foreign Application Priority Data
May 11, 2012 (JP) 2012-109955

(51) Int. Cl. B23K 9/32; B23K 26/14; B23K 9/173; B23K 9/167; B23K 10/02

(52) U.S. Cl. CPC B23K 9/325; B23K 9/167; B23K 10/02; B23K 9/173; B23K 26/1464

(57) ABSTRACT

A welding method in which an inert gas is supplied to the surface of an iron material from inside a cylindrical welding nozzle, and the surface of the iron material to which the inert gas is being supplied by the welding nozzle is heated, wherein oxygen in the atmosphere sucked by a drop in atmospheric pressure caused by the flow of the inert gas is introduced into a molten pool produced in the surface of the iron material. Consequently, it is possible to make the depth of penetration of the molten pool deeper by introducing oxygen into the molten pool and increase welding efficiency without preparing an additional oxygen supply source as in dual shield TIG welding.

### TECHNICAL FIELD

One embodiment of the present invention relates to a welding method, a welding nozzle and a welding device, and relates to a welding method, a welding nozzle and a welding device that supply inert gas onto a surface of a metallic material.

### BACKGROUND TECHNOLOGY

Since tungsten inert gas (TIG) welding is high in surface quality and provides fewer defects of welding, it is used for welding of precision apparatuses and high-pressure pipes. However, the TIG welding has defects where depth of penetration of a molten pool is shallow and a welding efficiency is low. It is known that it is possible to deepen the depth of penetration by introducing oxygen into the molten pool. However, when oxygen is introduced into the molten pool, a problem where a tungsten electrode is easily consumed with that oxygen occurs. Then, in Patent Literature 1 below, a technology of double shielded TIG welding to be doubly surrounded with an inner nozzle surrounding a side of a tungsten electrode and an outer nozzle surrounding a side of the inner nozzle and to separately distribute gas to the nozzles, respectively, is disclosed. In the technology of Patent Literature 1, a dual gas supply system with Ar gas and O₂ gas is prepared. Since Ar gas is distributed within the inner nozzle and mixed gas of Ar gas and O₂ gas is distributed between the inner nozzle and the outer nozzle, while consumption of a tungsten electrode due to oxygen is prevented, oxygen is introduced into a molten pool and the depth of penetration is deepened.

### PRIOR ART DOCUMENT

### Patent Literature

Patent Literature 1: Japanese Patent Application Laid-Open No. 2004-298963

### SUMMARY OF THE INVENTION

### Problem to be Solved by the Invention

However, in the technology above, a dual gas supply system with Ar gas and O₂ gas, and a special welding torch compatible with the dual gas supply system are required. Consequently, there are defects that the gas supply system and the welding torch become complicated and expensive. Further, since the dual gas supply system is required, there is a defect that gas for welding becomes expensive.

One embodiment of the present invention has been accomplished in light of the problem above, and the objective is to provide an arc welding method, a nozzle for arc welding and an arc welding device where oxygen is introduced into a molten pool with a simple technique to further deepen depth of penetration of the molten pool, and a welding efficiency is enhanced.

One embodiment of the present invention is a welding method, including

an inert gas supply step to supply inert gas to a surface of a metallic material from the inside of a cylindrical welding nozzle;

a heating step to heat the surface of the metallic material where the inert gas has been supplied by the welding nozzle in the inert gas supply step; and

an oxygen introduction step to introduce oxygen in the atmosphere that has been suctioned due to a reduction of pressure generated in association with a flow of the inert gas in the inert gas supply step, into a molten pool generated on the surface of the metallic material in the heating step.

According to this configuration, in the welding method where the inert gas is supplied onto the surface of the metallic material from the inside of the cylindrical welding nozzle, and the surface of the metallic material where the inert gas has been supplied by the welding nozzle is heated; oxygen in the atmosphere that has been suctioned due to a reduction in pressure generated in association with a flow of the inert gas is introduce into a molten pool generated on the surface of the metallic material. Consequently, even though a separate supply source of oxygen is not prepared as in the double shielded TIG welding, oxygen is introduced into the molten pool and depth of penetration of the molten pool is further deepened, and a weld efficiency can be enhanced.

In this case, the welding nozzle has

a nozzle inner cylinder where inert gas is distributed inside and

a nozzle outer cylinder where atmosphere that has been suctioned due to a reduction of pressure generated in association with a flow of the inert gas that is distributed within the nozzle inner cylinder in a gap with the nozzle inner cylinder while surrounding a side surface of the nozzle inner cylinder; and

in the inert gas supply step, inert gas is supplied to a metallic material from the inside of the nozzle inner cylinder; and

in the oxygen introduction step, while the atmosphere that has been suctioned due to the reduction of pressure generated in association with a flow of the inert gas that is distributed within the nozzle inner cylinder is distributed in the gap between the nozzle inner cylinder and the nozzle outer cylinder, the oxygen in the atmosphere can be introduced into the molten pool.

According to this configuration, the welding nozzle has

the nozzle inner cylinder where the inert gas is distributed inside, and

the nozzle outer cylinder where the atmosphere that has been suctioned due to a reduction of pressure generated in association with a flow of the inert gas that is distributed in the nozzle inner cylinder is distributed to the gap with the nozzle inner cylinder while surrounding the side of the nozzle inner cylinder. Further, the inert gas is supplied to the metallic material from the inside of the nozzle inner cylinder, and while the atmosphere that has been suctioned due to a reduction of pressure generated in association with a flow of the inert gas that is distributed in the nozzle inner cylinder is distributed to the gap between the nozzle inner cylinder and the nozzle outer cylinder, oxygen in the atmosphere is introduced into a molten pool. Consequently, oxygen can be introduced into the molten pool only with the welding nozzle with this simple structure having the nozzle inner cylinder and the nozzle outer cylinder.

In this case, the welding nozzle has a gap variable unit that can adjust size of the gap between the nozzle inner cylinder and the nozzle outer cylinder is adjustable; and in the oxygen introduction step, an amount of the atmosphere that is distributed in the gap between the nozzle inner cylinder and the nozzle outer cylinder is controlled by adjusting the size of the gap between the nozzle inner cylinder and the nozzle outer cylinder by the gap variable unit, and an amount of oxygen to be introduced into the molten pool can be controlled.

The amount of oxygen to be introduced in order to bring the molten pool into the ideal state varies depending upon the welding state. However, with this configuration, the welding nozzle has the gap variable unit that can adjust the size of the gap between the nozzle inner cylinder and the nozzle outer cylinder, and the amount of the atmosphere that is distributed in the gap between the nozzle inner cylinder and the nozzle outer cylinder is controlled by adjusting the size of the gap between the nozzle inner cylinder and the nozzle outer cylinder by the gap variable unit, and the amount of oxygen to be introduced into the molten pool is controlled. Consequently, the amount of oxygen to be introduced into the molten pool can be controlled by corresponding to various states of welding.

Further, the size of the gap between the nozzle inner cylinder and the nozzle outer cylinder can be greater than 1 mm but 5 mm or less.

If the size of the gap between the nozzle inner cylinder and the nozzle outer cylinder is greater than 1 mm, a reverse flow of the atmosphere that is distributed in the gap between the nozzle inner cylinder and the nozzle outer cylinder can be prevented. Further, if the size of the gap between the nozzle inner cylinder and the nozzle outer cylinder is 5 mm or less, a sufficient amount of the atmosphere can be distributed.

Further, the welding nozzle has atmosphere introduction hole parts that lead to the inside of the welding nozzle from the outside of the welding nozzle, and where the atmosphere that has been suctioned due to a reduction of pressure generated in association with a flow of the inert gas that is distributed within the welding nozzle is distributed; and in the oxygen introduction step, while the atmosphere that has been suctioned due to a reduction of pressure generated in association with a flow of the inert gas that is distributed within the welding nozzle is distributed into the atmosphere introduction hole parts, oxygen in the atmosphere can be introduced into the molten pool.

According to this configuration, the welding nozzle has the atmosphere introduction hole parts that lead to the inside of the welding nozzle from the outside of the welding nozzle, and where the atmosphere that has been suctioned due to a reduction of pressure generated in association with a flow of the inert gas that is distributed within the welding nozzle is distributed, and while the atmosphere that has been suctioned due to a reduction of pressure generated in association with a flow of the inert gas that is distributed within the welding nozzle is distributed to the atmosphere introduction hole part, oxygen in the atmosphere is introduced into the molten pool. Consequently, oxygen can be introduced into the molten pool only with the welding nozzle with this simple structure having the atmosphere introduction hole parts.

In this case, the welding nozzle has an introduction hole variable unit that can adjust size of the atmosphere introduction hole parts, and in the oxygen introduction step, the amount of the atmosphere that is distributed in the atmosphere introduction hole parts is controlled by adjusting the size of the atmosphere introduction hole parts by the introduction hole variable unit, and the amount of oxygen to be introduced into the molten pool can be controlled.

The amount of oxygen to be introduced in order to bring the molten pool to the ideal state varies depending upon a welding state. However, with this configuration, the welding nozzle has the introduction hole variable unit that can adjust the size of the atmosphere introduction hole parts, and the amount of the atmosphere that is distributed in the atmosphere introduction hole parts is controlled by adjusting the size of the atmosphere introduction hole parts by the introduction hole variable unit, and the amount of oxygen to be introduced into the molten pool is controlled.

Further, one embodiment of the present invention is a welding nozzle that supplies inert gas to a surface of a metallic material from the inside of the cylinder welding nozzle, and that is used for welding that heats the surface of the metallic material where the inert gas has been supplied by the welding nozzle, including:

a nozzle inner cylinder where the inert gas is distributed inside, and

a nozzle outer cylinder where atmosphere that has been suctioned due to a reduction of pressure generated in association with a flow of the inert gas that is distributed within the nozzle inert cylinder is distributed in the gap with the nozzle inner cylinder while surrounding the side surface of the nozzle inner cylinder, wherein

oxygen in the atmosphere is introduced into a molten pool generated on the surface of the metallic material due to heating by distributing the atmosphere that has been suctioned due to a reduction of pressure generated in association with a flow of the inert gas that is distributed within the nozzle inner cylinder in the gap between the nozzle inner cylinder and the nozzle outer cylinder.

In this case, [the welding nozzle] is equipped with a gap variable unit that can adjust size of the gap between the nozzle inner cylinder and the nozzle outer cylinder, and the amount of the atmosphere that is distributed in the gap between the nozzle inner cylinder and the nozzle outer cylinder is controlled by adjusting the size of the gap between the nozzle inner cylinder and the nozzle outer cylinder by the gap variable unit, and the amount of oxygen to be introduced into the molten pool can be controlled.

Further, in the oxygen introduction step, oxygen in the atmosphere can be introduced into the molten pool so as to be 70 ppm to 300 ppm of the amount of oxygen in the molten pool.

In the oxygen introduction step, depth of penetration can be deepened further certainly by introducing oxygen in the atmosphere into the molten pool so as to be 70 ppm to 300 ppm of the amount of oxygen in the molten pool.

Further, in the inert gas supply step, the inert gas can be supplied at 1 to 9 LM of a flow rate of inert gas.

In the inert gas supply step, the depth of penetration of the molten pool can be deepened further certainly by supplying the inert gas at 1 to 9 LM of a flow rate of the inert gas.

Further, one embodiment of the present invention is the welding nozzle that supplies inert gas to a surface of the metallic material from the inside of the cylindrical welding nozzle, and that is used for welding that heats the surface of the metallic material where the inert gas has been supplied by the welding nozzle, including: atmosphere introduction hole parts that lead to the inside of the welding nozzle from the outside of the welding nozzle, wherein

oxygen in the atmosphere is introduced into a molten pool generated on the surface of the metallic material due to heating, by distributing the atmosphere that has been suctioned due to a reduction of pressure generated in association with a flow of the inert gas that is distributed within the welding nozzle to the atmosphere introduction hole parts.

In this case, the atmosphere introduction variable that can adjust size of the atmosphere introduction hole part is included, and an amount of the atmosphere that is distributed in the atmosphere introduction hole part is controlled by adjusting the size of the atmosphere introduction hole part with the introduction hole variable unit, and an amount of oxygen to be introduced into the molten pool can be controlled.

Further, one embodiment of the present invention is welding equipment, including:

the welding nozzle of the present invention,

a thermal source to heat the surface of the metallic material where inert gas has been supplied by the welding nozzle of the present invention,

a molten pool monitoring unit that observes a molten pool, and

an oxygen introduction amount control unit that controls an amount of oxygen to be introduced into the molten pool by the gap variable unit of the welding nozzle of the present invention or the introduction hole variable unit of the welding nozzle of the present invention based upon a state of the molten pool monitored by the molten pool monitoring unit.

According to this configuration, the oxygen introduction amount control unit controls an amount of oxygen to be introduced into the molten pool by the gap variable unit of the welding nozzle of the present invention or the introduction hole variable unit of the welding nozzle of the present invention based upon a state of the molten pool monitored by the molten pool monitoring unit. Consequently, a more excellent molten pool can be obtained by controlling the amount of oxygen to be introduced into the molten pool based upon the state of the molten pool.

### Effect of the Invention

According to an arc welding method, an arc welding nozzle and an arc welding device in one embodiment of the present invention, it becomes possible to introduce oxygen into a molten pool with a simpler technique to further deepen depth of penetration of the molten pool, and to enhance a weld efficiency.

### BRIEF DESCRIPTION OF THE INVENTION

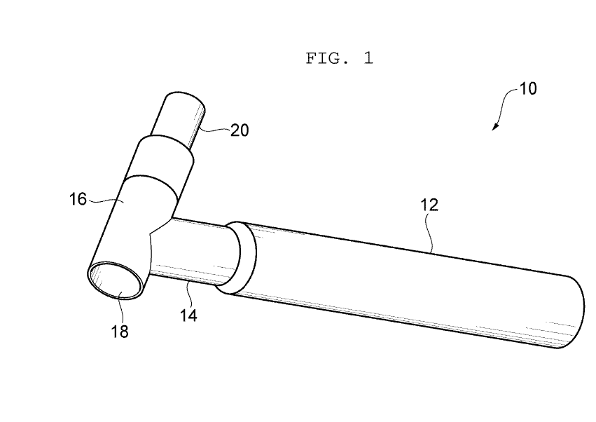

FIG. 1 is a perspective view showing a torch in the First Embodiment.

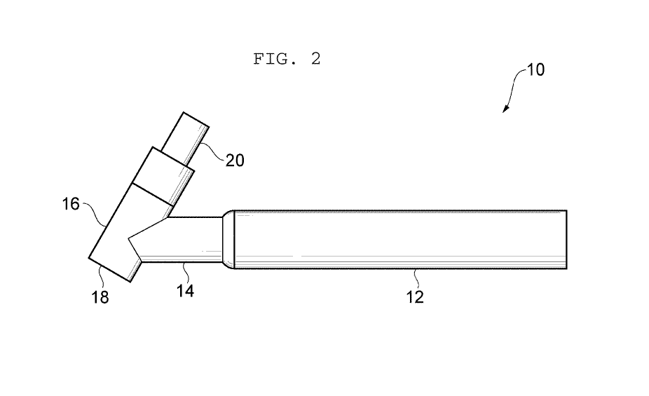

FIG. 2 is a side view of the torch in FIG. 1.

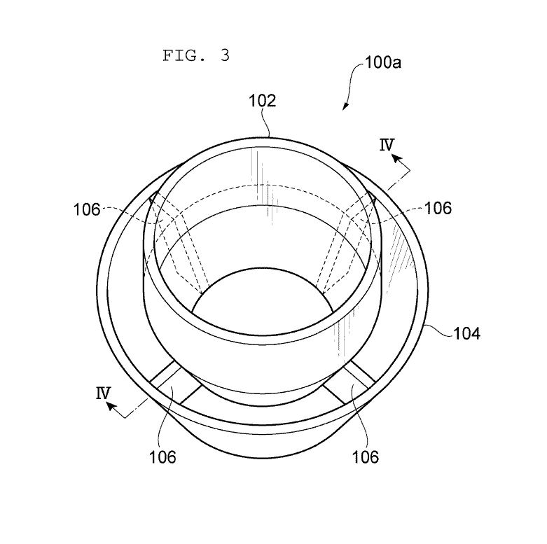

FIG. 3 is a perspective view of a nozzle in the First Embodiment.

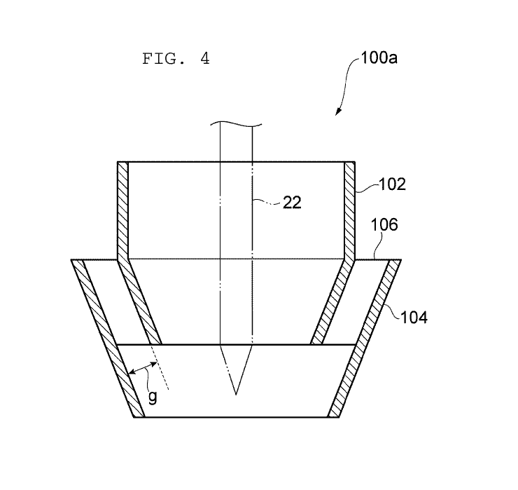

FIG. 4 is a cross-sectional view at a Line IV in FIG. 3.

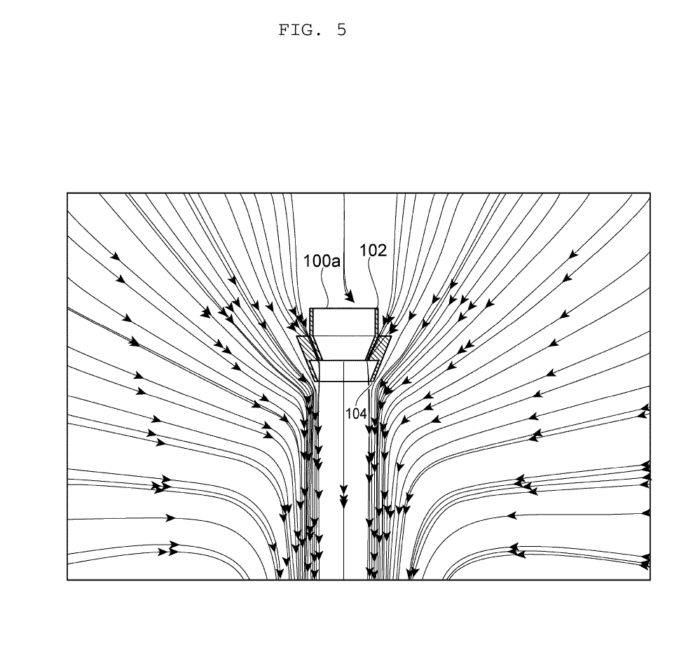

FIG. 5 shows air currents around the periphery of the nozzle on the occasion of introducing inert gas to the nozzle of the First Embodiment.

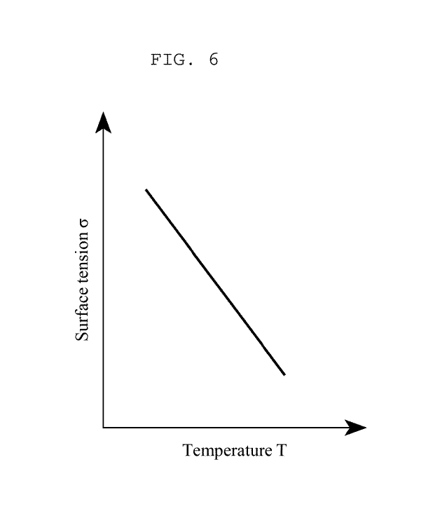

FIG. 6 is a graph showing a relationship between temperature and surface tension of a molten pool under the inert gas atmosphere.

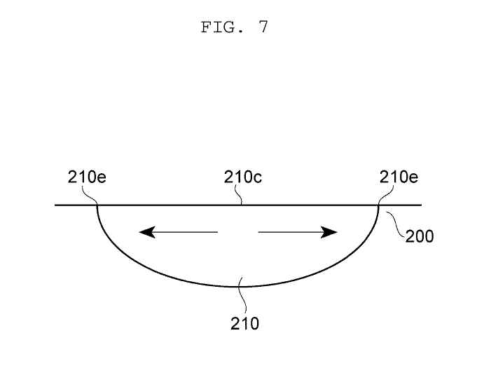

FIG. 7 shows shape of the molten pool and flowage of molten metal.

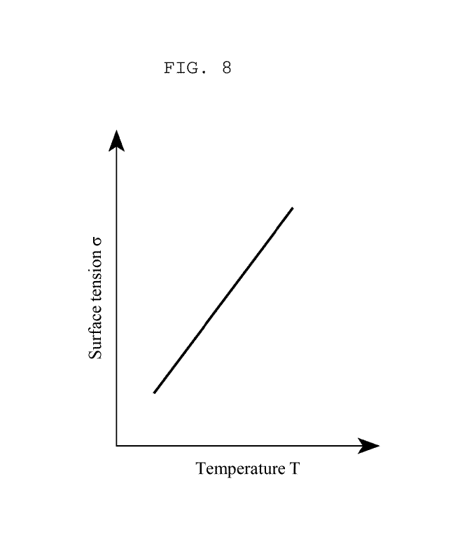

FIG. 8 is a graph showing a relationship between temperature and surface tension of the molten pool under atmosphere containing oxygen.

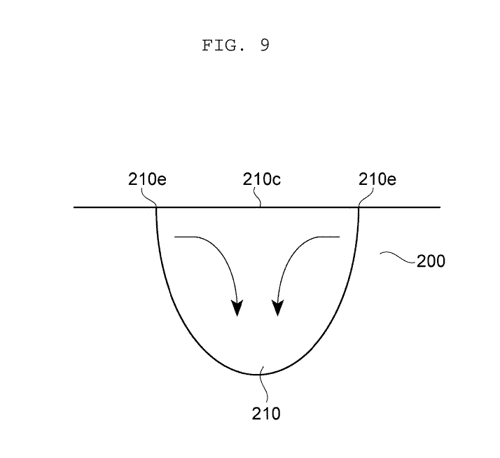

FIG. 9 shows shape of the molten pool and flowage of molten metal under the atmosphere containing oxygen.

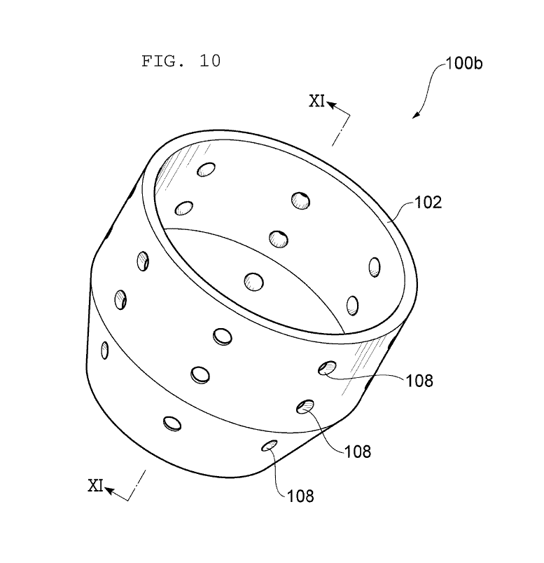

FIG. 10 is perspective view showing a nozzle of the Second Embodiment.

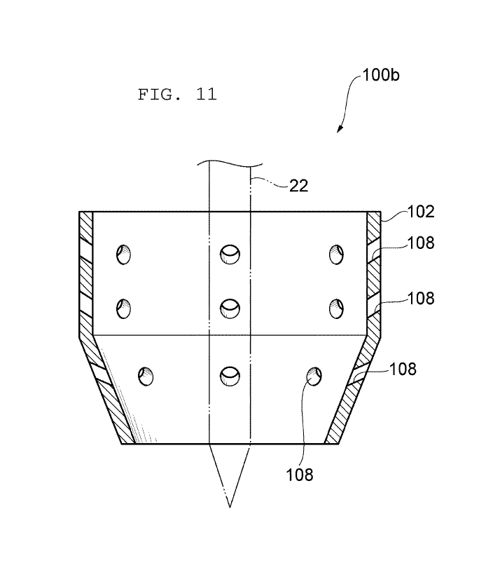

FIG. 11 is a cross-sectional view showing at a Line XI in FIG. 10.

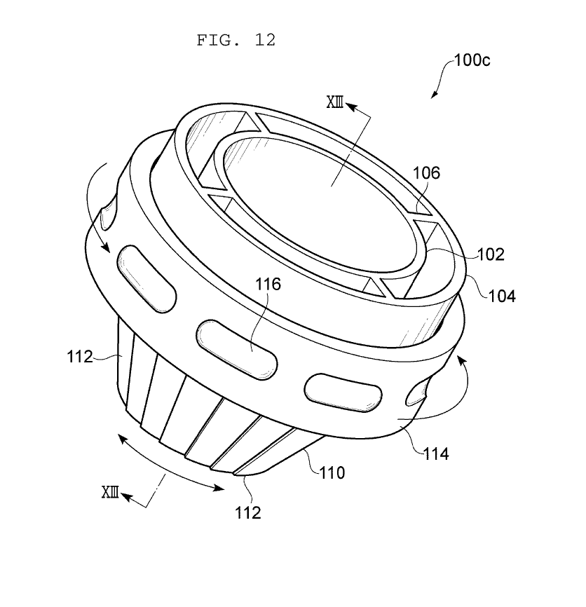

FIG. 12 is a perspective view showing a nozzle of the Third Embodiment.

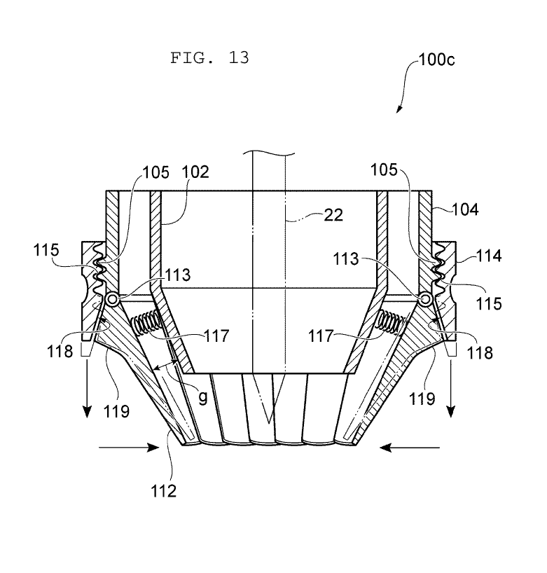

FIG. 13 is a cross-sectional view at a Line XIII in FIG. 12.

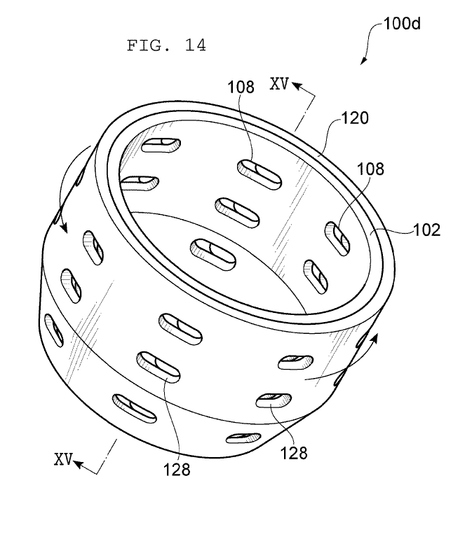

FIG. 14 is a perspective view showing a nozzle of the Fourth Embodiment.

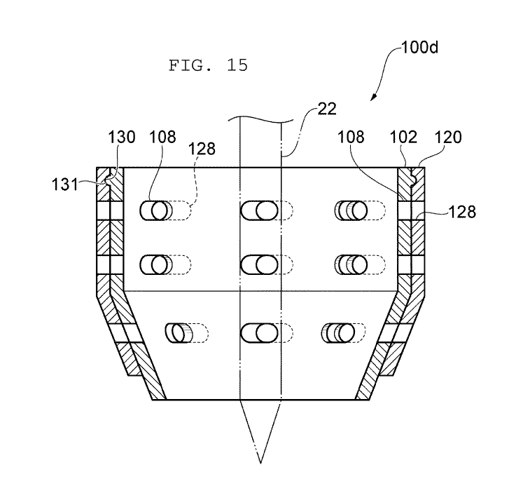

FIG. 15 is a cross-sectional view at a Line XV in FIG. 14.

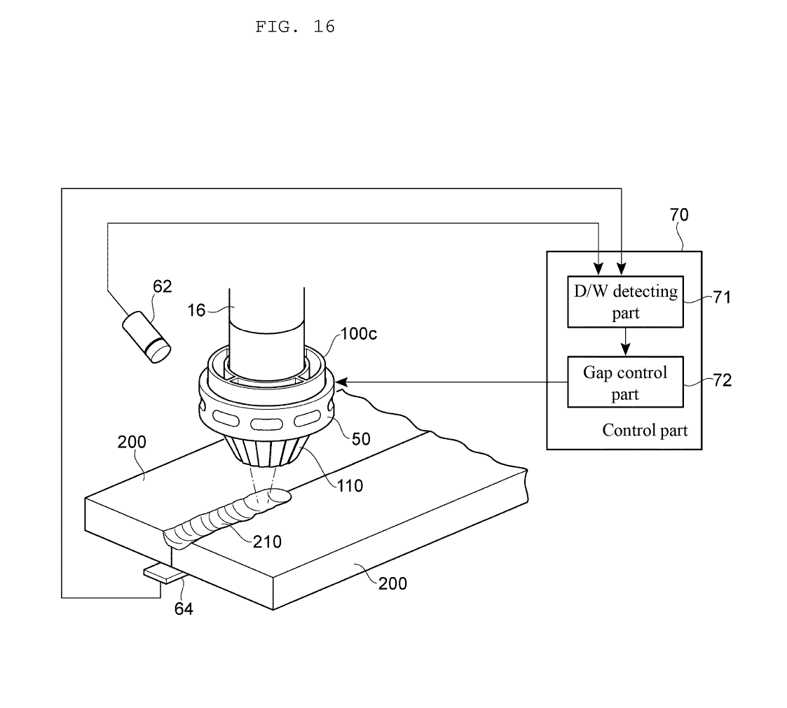

FIG. 16 is a perspective view showing a welding device of the Fifth Embodiment.

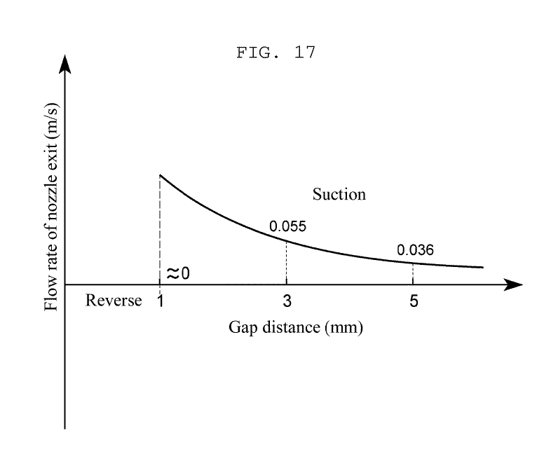

FIG. 17 is a graph showing a relationship between gap distance of a nozzle and a flow rate of a nozzle exit in an experimental example.

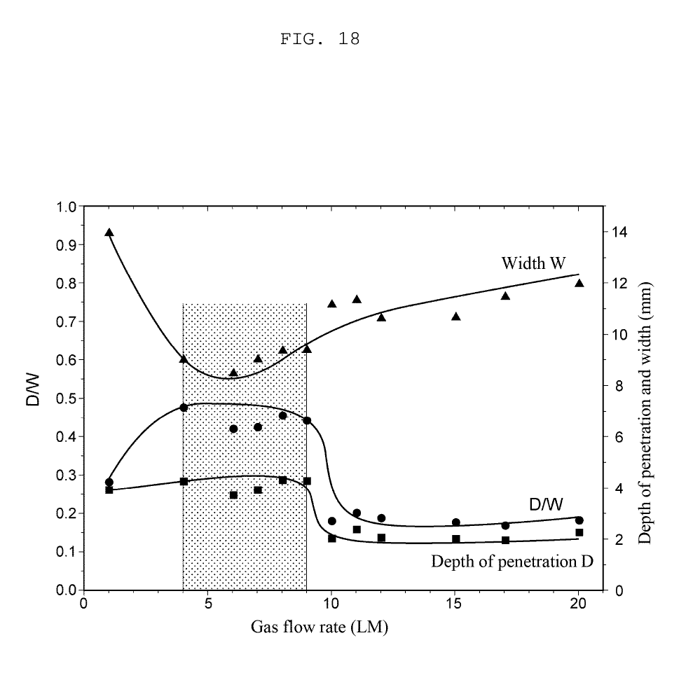

FIG. 18 is a graph showing a relationship between a gas flow rate and D/W, which is a ratio of depth D of the molten pool to width W of the molten pool in the experimental example.

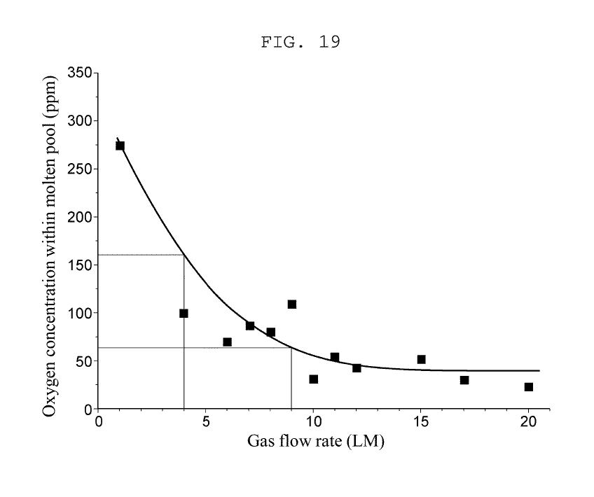

FIG. 19 is a graph showing the relationship between a gas flow rate and oxygen concentration within a molten pool in the experimental example.

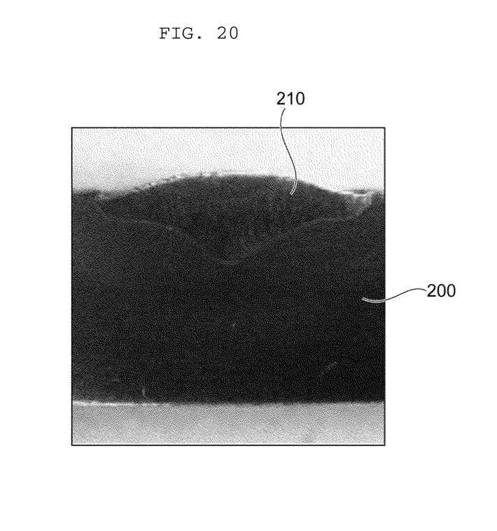

FIG. 20 shows a molten pool when a gas flow rate in the experimental example is 1 LM.

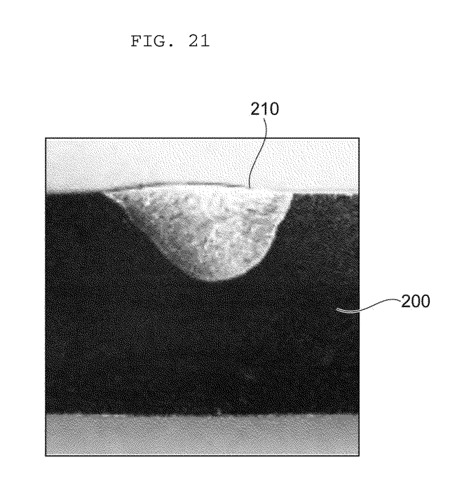

FIG. 21 shows a molten pool when a gas flow rate in the experimental example is 4 LM.

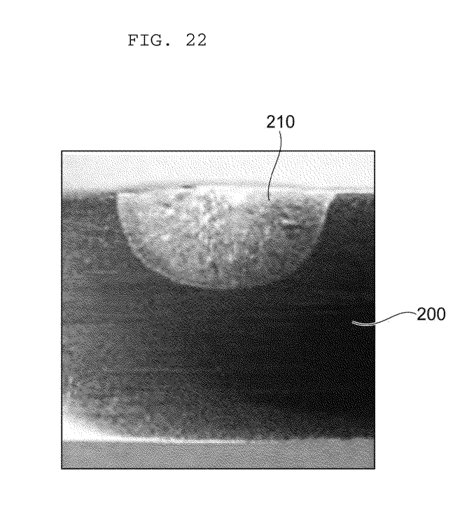

FIG. 22 shows a molten pool when a gas flow rate in the experimental example is 9 LM.

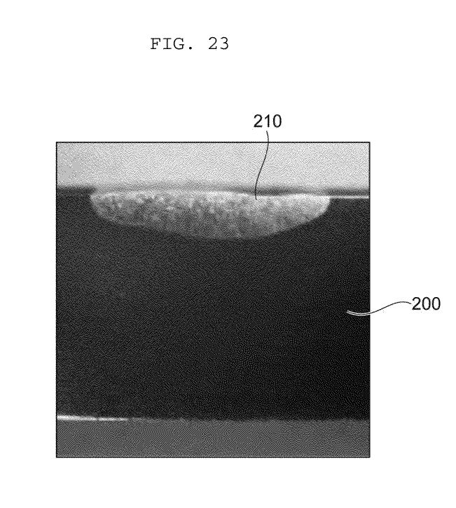

FIG. 23 shows a molten pool when a gas flow rate in the experimental example is 10 LM.

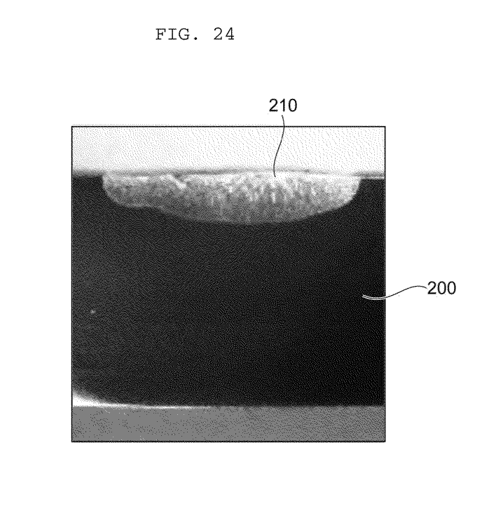

FIG. 24 shows a molten pool when a gas flow rate in the experimental example is 20 LM.

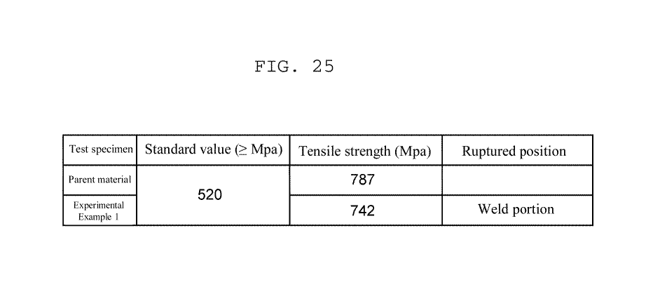

FIG. 25 is a table showing strength of a welding part in the experimental example.

### MODE FOR CARRYING OUT THE INVENTION

Hereafter, the welding method, the welding nozzle and the welding device relating to embodiments of the present invention will be explained in detail.

First, the First Embodiment of the present invention is explained. In the present embodiment, a welding nozzle relating to the present embodiment is mounted to a torch that is used for common TIG welding. Consequently, depth of penetration of a molten pool is increased by introducing oxygen, which is a surface-active element, into the molten pool. As the surface-active element, other than oxygen, sulfur, selenium and tellurium are exemplified. As a metallic material where the depth of penetration of the molten pool is increased by introducing the surface-active element into the molten pool, a metallic material containing any of, for example, Fe, Ni, an alloy of Fe and Ni and stainless steel is exemplified.

First, the torch for TIG welding is briefly explained. As shown in FIG. 1 and FIG. 2, a torch 10 used in First Embodiment of the present invention is equipped with a handle 12, a connection 14, a torch body 16, a gas feed port part 18 and a sleeve 20. The torch 10 used in the present embodiment has a structure similar to that used for common TIG welding. The handle 12 has circular cylindrical shape that is easily gripped by an operator. Power for generating arc is externally supplied to the handle 12. A tungsten electrode within the sleeve 20 and an external power source are electrically connected via a power line within the handle 12. The torch body 16 having cylindrical shape is linked with the handle 12 via the connection 14 by forming an angle, for example at 60°. One end of the torch body 16 is equipped with a gas feed port part 18 where inert gas, such as Ar or He, is introduced. Furthermore, as the inert gas to be used, it does not have to be 100% Ar gas or 100% He gas, but it may contain a quantity of other element gas, such as H₂. The other end of the torch body 16 is equipped with the sleeve 20 that surrounds a rod-state tungsten electrode, and where a welding nozzle to be described later is mounted.

Hereafter, the welding nozzle of the present embodiment is explained. As shown in FIG. 3 and FIG. 4, a welding nozzle 100a of the present embodiment is equipped with a nozzle inner cylinder 102, a nozzle outer cylinder 104 and connecting wings 106. The nozzle inner cylinder 102 distributes inert gas inside while surrounding a side surface of the tungsten electrode 22 with its inner wall surface. The nozzle outer cylinder 104 distributes the atmosphere that has been suctioned due to a reduction of pressure generated in association with a flow of the inert gas that is distributed in the nozzle inner cylinder 102 in the gap with the nozzle inner cylinder 102 while surrounding a side surface of the nozzle inner cylinder 102. The connecting wings 106 connect the nozzle inner cylinder 102 and the nozzle outer cylinder 104 at predetermined intervals g, respectively.

Herein, the interval g between the nozzle inner cylinder 102 and the nozzle outer cylinder 104 can be set to, for example, 1 mm to 5 mm, i.e., 3 mm, when a flow rate of the inert gas is 4 LM to 9 LM and arc length, which is the length of an arc formed between the tungsten electrode 22 and a metallic material to be welded, is 3 mm. If the arc length becomes longer, an effect to shield a molten pool 210 of the inert gas is decreased, and an amount of oxygen to be introduced to the molten pool 210 is increased. Consequently, the optimum interval g fluctuates based upon the flow rate of the inert gas and the arc length. Further, a positional relationship of a tip of the nozzle outer cylinder 104 to that of the tungsten electrode 22 is a positional relationship where the tip of the nozzle outer cylinder 104 protrudes more than the tip of the tungsten electrode 22 toward a direction of the metallic material to be welded and the entire tungsten electrode 22 is surrounded by the nozzle outer cylinder 104. However, the tip of the nozzle outer cylinder 104 can be arranged at a position recessed from the metallic material from the tip of the nozzle cylinder 102. Even in such positional relationship, an effect for suction in the atmosphere is demonstrated. Further, the tungsten electrode 22 can be arranged at a position recessed inside the welding nozzle 100a from the metallic material to be welded, and the upper limit should be a position recessed to the inside by the arc length compared to one at the side of the metallic material to be welded by the tip of either the nozzle inner cylinder 102 or the nozzle outer cylinder 104. Although it is desirable that the tip of the tungsten electrode 22 can be visually confirmed from a viewpoint of welding work, if the tungsten electrode 22 is recessed to the inside than the tip of the nozzle 100a within the range of the arc length, these are joinable.

Hereafter, action and effects of the welding nozzle 100a of the present embodiment are explained. Upon arc welding, inert gas is distributed within the nozzle inner cylinder 102, and the inert gas is supplied to a surface of a metallic material to be welded and the tungsten electrode 22 is shielded. Further, voltage is applied between the tungsten electrode 22 and the metallic material, and an arc is generated. The surface of the metallic material is heated by the arc, and a molten pool is formed. In this case, as it is known as Bernoulli's theorem, pressure is reduced in association with distribution of inert gas within the nozzle inner cylinder 102. In association with reduction of the pressure within the nozzle inner cylinder 102, as indicated with arrows in FIG. 5, the suctioned atmosphere is distributed in the gap between the nozzle inner cylinder 102 and the nozzle outer cylinder 104. Oxygen in the suctioned atmosphere is introduced into the molten pool. Furthermore, it is believed that the atmosphere would be introduced into the molten pool via the gap between the nozzle inner cylinder 102 and the nozzle outer cylinder 104 even due to a reduction of pressure by a plasma air current generated between the tungsten electrode 22 and the molten pool, other than the inert gas that is distributed within the nozzle inner cylinder 102.

As shown in FIG. 6, with iron group metal, surface tension a is reduced in association with an increase of temperature T. Therefore, as shown in FIG. 7, in the molten pool 210 of an iron material 200, the surface tension becomes greater in a molten pool end portion 210e at lower temperature than a molten pool center portion 210c at higher temperature. Consequently, as shown in FIG. 7, on the surface of the molten pool 210, flowage from the molten pool center portion 210c to the molten pool end portion 210e occurs. Consequently, in general, depth of penetration of the molten pool 210 becomes shallower with TIG welding.

In the meantime, when oxygen, which is surface-active element, is introduced into the molten pool 210, as shown in FIG. 8, the surface tension a is increased in association with the increase in the temperature T. Therefore, as shown in FIG. 9, in the molten pool 210 of the iron material 200, the surface tension becomes greater in the molten pool center portion 210c at higher temperature than the molten pool end portion 210e at lower temperature. Consequently, as shown in FIG. 9, flowage from the molten pool end portion 210e to the molten pool center portion 210c occurs on the surface of the molten pool 210. Therefore, it becomes possible to deepen the depth of penetration of the molten pool 210 with TIG welding using the welding nozzle 100a of the present embodiment. Furthermore, in Fe or an alloy, such as stainless steel containing Fe as a principal element, the amount of oxygen to cause the depth of penetration of the molten pool 210 to be deeper is in a case when the amount of oxygen in the molten pool 210 is 70 ppm to 300 ppm, and is in a case when the amount of oxygen in the molten pool 210 is 70 ppm to 160 ppm. Furthermore, on the occasion of introducing oxygen in the atmosphere into the molten pool 210, nitrogen in the atmosphere is also introduced at the same time. When it is desired to suppress the introduction of nitrogen in the atmosphere, implementation of the welding method of the present embodiment in the atmosphere where a ratio of oxygen is increased and a ratio of nitrogen is decreased compared to the normal atmosphere can be considered. Thus, in the present embodiment, it is possible to control the amount of oxygen to be introduced into the molten pool 210 by adjusting a composition of the atmosphere itself, as well.

In the present embodiment, in the welding method where inert gas is supplied onto a surface of the iron material 200 from the inside of the cylindrical welding nozzle 100a and the surface of the iron material 200 where inert gas has been supplied by the welding nozzle 100a is heated, oxygen in the atmosphere that has been suctioned due to a reduction of pressure generated in association with a flow of the inert gas is introduced into the molten pool 210 generated on the surface of the iron material 200. Consequently, even though another supply source of oxygen is not prepared as with double-shielded TIG welding, oxygen is introduced into the molten pool 210 and the depth of penetration of the molten pool 210 is further deepened and a weld efficiency can be enhanced.

In the present embodiment, the welding nozzle 100a has the nozzle inner cylinder 102 where inert gas is distributed inside, and the nozzle outer cylinder 104 where the atmosphere that has been suctioned due to a reduction of pressure in association with a flow of the inert gas that is distributed in the nozzle inner cylinder 102 is distributed in the gap with the nozzle inner cylinder 102 while surrounding the side surface of the nozzle inner cylinder 102. Further, while inert gas is supplied to the iron material 200 from the inside of the nozzle inner cylinder 102 and the atmosphere that has been suctioned due to a reduction of pressure generated in association with a flow of inert gas that is distributed in the nozzle inner cylinder 102 is distributed in the gap between the nozzle inner cylinder 102 and the nozzle outer cylinder 104, oxygen in the atmosphere is introduced into the molten pool 210. Consequently, oxygen can be introduced into the molten pool 210 only with the welding nozzle 100a with this simple structure having the nozzle inner cylinder 102 and the nozzle outer cylinder 104.

Hereafter, the Second Embodiment of the present invention is explained. In the present embodiment, oxygen in the atmosphere is introduced into the molten pool 210 using a welding nozzle with different shape from that in the First Embodiment. As shown in FIG. 10 and FIG. 11, a welding nozzle 100b of the present embodiment is equipped with a plurality of atmosphere introduction hole parts 108 that lead to the inside of the nozzle inner cylinder 102 from the outside of the nozzle inner cylinder 102 on the side surface of the nozzle inner cylinder 102. As shown in FIG. 11, orientation of each hole of the atmosphere introduction hole parts 108 can be orientation to lead to the inside of the nozzle inner cylinder 102 while being orientated toward the metallic material to be welded from the outside of the nozzle inner cylinder 102.

When inert gas is distributed within the nozzle inner cylinder 102, as similar to the First Embodiment, the atmosphere that has been suctioned from the outside of the nozzle inner cylinder 102 is distributed to the atmosphere introduction hole parts 108 due to a reduction of pressure generated in association with a flow of the inert gas. Oxygen contained in the atmosphere introduced from the atmosphere introduction hole parts 108 is then introduced into the molten pool 210.

In the present embodiment, the welding nozzle 100b has the atmosphere introduction hole parts 108 that lead to the inside of the welding nozzle 100b from the outside of the welding nozzle 100b, and where the atmosphere that has been suctioned due to a reduction of pressure generated in association with a flow of the inert gas that is distributed within the welding nozzle 100b is distributed, and while the atmosphere that has been suctioned due to a reduction of pressure generated in association with a flow of the inert gas that is distributed within the welding nozzle 100b is distributed in the atmosphere introduction hole parts 108, oxygen in the atmosphere is introduced into the molten pool 210. Consequently, oxygen can be introduced into the molten pool 210 only with the welding nozzle 100b with the simple structure having the atmosphere introduction hole parts 108.

Hereafter, the Third Embodiment of the present invention is explained. In the present embodiment, an amount of oxygen to be introduced into the molten pool 210 is controlled by controlling the gap between the nozzle inner cylinder 102 and the nozzle outer cylinder 104 in the First Embodiment. As shown in FIG. 12 and FIG. 13, the welding nozzle 100c of the present embodiment is equipped with a variable nozzle 110 and a nut 114 in addition to the nozzle inner cylinder 102, the nozzle outer cylinder 104 and the connecting wing 106 as similar to the First Embodiment above.

The variable nozzle 110 is configured such that ends of a plurality of long thin nozzle pieces 112 are overlapped with each other. Ends of the nozzle pieces 112 are connected to an end of the nozzle outer cylinder 104 with hinges 113 to be flexible, respectively. Coil springs 117 are inserted between a surface of the nozzle pieces 112 and an outer surface of the nozzle inner cylinder [102], respectively. The coil spring 117 provides the force to open toward the outside of the welding nozzle 100c to the nozzle pieces 112 connected to the nozzle outer cylinder 104 with the hinges 113, respectively. Furthermore, the coil spring 117 may be an axle spring that provides force to open itself toward the outside of the welding nozzle 100c relative to the nozzle piece 112 in the hinges 113, respectively. Nozzle piece convex parts 119 that protrude toward the outside of the welding nozzle 100c are established on the outer surfaces in the vicinity of the hinges 113 of the nozzle pieces 112, respectively.

A plurality of nut concave parts 116 are established around the outer periphery of the nut 114 so as to allow an operator to easily grip them. Screw threads 115 that will be engaged with screw threads 105 are established on the outer periphery of the nozzle outer cylinder 104 on the inner periphery of the nut 114, respectively. When the nut 114 is rotated in the circumferential direction of the welding nozzle 100c due to the screw threads 105 and 115, the nut 114 slides in a direction approaching to or receding from a metallic material to be welded on the nozzle outer cylinder 104. Slopes 118 inclining toward the outside of the welding nozzle 100c are established at the end portion at the metallic material side to be welded on the inner periphery of the nut 114.

When the nut 114 is rotated in the circumferential direction of the welding nozzle 100c and the nut 114 is allowed to slide in the direction approaching to a metallic material to be welded on the nozzle outer cylinder 104, the slopes 118 slides on the nozzle piece convex parts 119 of the nozzle pieces 112 while tucking a nozzle piece convex parts 119 inward, respectively. Consequently, the variable nozzle 110 made from the nozzle pieces 112 where their end portions are overlapped with each other is pursed, and the gap g is reduced. In the meantime, the nut 114 is rotated in the reverse direction and the nut 114 is allowed to slide on the nozzle outer cylinder 104 in the direction receding from a metallic material to be welded, the distance where nozzle piece convex part 119 is tucked inward by the slope 118 becomes shorter. Consequently, the variable nozzle 110 is expanded due to spring force of the coil spring 117, and the gap g is increased.

The amount of oxygen to be introduced in order to bring the molten pool 210 to an ideal state varies depending upon the state of welding. However, in the present embodiment, the welding nozzle 100c can adjust the size of the gap g between the nozzle inner cylinder 102 and the nozzle outer cylinder 104, and the amount of atmosphere that is distributed in the gap g between the nozzle inner cylinder 102 and the nozzle outer cylinder 104 is controlled by adjusting the size of the gap g between the nozzle inner cylinder 102 and the nozzle outer cylinder 104, and the amount of oxygen to be introduced into the molten pool 210 is controlled. Consequently, the amount of oxygen to be introduced into the molten pool 210 can be controlled by responding to various statuses of welding.

Hereafter, the Fourth Embodiment of the present invention is explained. In the present embodiment, the amount of oxygen to be introduced into the molten pool 210 is controlled by controlling the size of the atmosphere introduction hole part 108 in the Second Embodiment. As shown in FIG. 14 and FIG. 15, a welding nozzle 100d of the present embodiment is equipped with a nozzle outer cylinder 120 where its inner periphery is closely located on the outer periphery of the nozzle inner cylinder 102 in addition to the nozzle inner cylinder 102 of the Second Embodiment. The nozzle outer cylinder 120 is equipped with a plurality of atmosphere introduction hole parts 128 that are long in a circumferential direction of the welding nozzle 100d on its side surface. Further, a plurality of atmosphere introduction hole parts 108 that are long in the circumferential direction of the welding nozzle 100d corresponding to the shape of the atmosphere introduction hole parts 128 are established at sites corresponding to the atmosphere introduction hole parts 128 of the nozzle outer cylinder 120 on the side of the nozzle inner cylinder 102, respectively.

A nozzle inner cylinder convex part 130 is established on the outer periphery of the nozzle inner cylinder 102. A nozzle outer cylinder concave part 131 is established on the inner periphery of the nozzle outer cylinder 120. Fitting of the nozzle inner cylinder convex part 130 into the nozzle outer cylinder concave part 131 with each other enables the nozzle inner cylinder 102 and the nozzle outer cylinder 120 to rotate in the circumferential direction of the welding nozzle 100d relative to each other while they are closely attached. An area at a site where the atmosphere introduction hole part 108 of the nozzle inner cylinder 102 is matched with the atmosphere introduction hole part 128 of the nozzle outer cylinder 120 is changed by rotating the nozzle inner cylinder 102 and the nozzle outer cylinder 120 relative to each other. Consequently, the substantial size of the atmosphere introduction hole parts 108 is adjustable, and the amount of atmosphere that is distributed in the atmosphere introduction hole part 108 by adjusting the size of the atmosphere introduction hole part 108, and the amount of oxygen to be introduced into the molten pool 210 is controlled. Consequently, the amount of oxygen to be introduced into the molten pool 210 can be controlled in response to various statuses of welding.

Hereafter, the Fifth Embodiment of the present invention is explained. In the present embodiment, a state of the molten pool 210 is monitored, and the amount of oxygen to be introduced into the molten pool [210] is controlled according to the state of the monitored molten pool 210. As shown in FIG. 16, a welding device of the present embodiment is equipped with the welding nozzle 100c of the Third Embodiment mounted on the torch body 16, a servo mechanism 50, a photoelectric sensor 62, a temperature sensor 64, a control part 70 and a not-shown gas supply source that supplies inert gas to the welding nozzle 100c. Furthermore, in the present embodiment, the welding nozzle 100d of the Fourth Embodiment is also applicable. The servo mechanism 50 drives the nut 114 of the welding nozzle 100c, and controls the gap g between the nozzle inner cylinder 102 and the nozzle outer cylinder 104 of the welding nozzle 100c. The photoelectric sensor 62 monitors width of the molten pool 210 and a direction of fluidity of the molten pool 210 using a semiconductor laser and a xenon lamp. The temperature sensor 64 measures temperature on the rear surface of the molten pool 210.

The control part 70 has a D/W detecting part 71 and a gap control part 72. The D/W detecting part 71 detects D/W, which is a ratio of the depth of penetration D to the width W of the molten pool 210, based upon a detection result(s) of the photoelectric sensor 62 and the temperature sensor 64. The D/W detecting part 71 can assume, for example, the depth of penetration D to be maximal when the width D of the molten pool 210 detected by the photoelectric sensor 62 becomes minimal. Alternatively, for example, the fluidity of the molten pool 210 detected by the photoelectric sensor 62 is as shown in FIG. 9, and the D/W detecting part 71 can assume the depth of penetration D as maximal when the fluidity is maximal. Alternatively, for example, when the temperature of the rear surface of the molten pool 210 detected by the temperature sensor 64 becomes maximal, the D/W detecting part 71 can assume the depth of penetration D as maximal. The gap control part 72 drives the servo mechanism 50 based upon D/W detected by the D/W detecting part 71, and feedback-controls the gap g of the welding nozzle 100c. The gap control part 72 controls the gap g of the welding nozzle 100c so as to maintain D/W at maximal due to the feedback control.

According to the present embodiment, the gap control part 72 of the control part 70 controls the amount of oxygen to be introduced into the molten pool 210 based upon the status of the molten pool 210 monitored by the photoelectric sensor 62 and the temperature sensor 64. Consequently, more excellent molten pool 210 can be obtained by controlling the amount of oxygen to be introduced into the molten pool 210 based upon the status of the molten pool 210.

Furthermore, the present invention is not limited to the embodiments above, but various modified forms are applicable. For example, in the embodiments above, the modes where the welding method, the welding nozzle and the welding equipment were applied to TIG welding were mainly explained, but the present invention shall not be limited to these, but is applicable to metal inert gas (MIG) welding, laser welding and plasma welding, as well.

### Experimental Example 1

Hereafter, experimental examples of the present invention are explained. The welding nozzle 100a shown in FIG. 3 and FIG. 4 was mounted to the sleeve 20 of the torch 10 shown in FIG. 1 and FIG. 2, and the iron material 200 was welded. A flow rate was changed within the range of 1 LM to 20 LM using Ar gas as inert gas. A welding current to be applied to the tungsten electrode 22 and the iron material 200 was set at 180 A, a welding rate was set at 2 mm/s and the arc length, which is the distance between the tip of the tungsten electrode 22 and the iron material 200, was set at 3 mm. An amount of oxygen in a molten pool was measured with a non-dispersive infrared absorption method using an oxygen-nitrogen analyzer (manufactured by HORIBA, Ltd., product name: EMGA-520). For samples for measurement of the amount of oxygen, a block with approximately 1 mm×1 mm×3 mm [of dimensions] was clipped from the molten pool, and after an oxidized film on the surface was polished and removed, they were ultrasonic-cleaned with acetone for 10 minutes, and in order to prevent oxidation of the surface, they were stored in acetone immediately before placing to a device.

First, a flow rate at the exit of the nozzle outer cylinder 104 of the welding nozzle 100a at the time of changing the gap g (gap distance) between the nozzle inner cylinder 102 and the nozzle outer cylinder 104 of the welding nozzle 100a to 1 mm, 3 mm and 5 mm is shown in FIG. 17. As shown in FIG. 17, the shorter the gap distance becomes, the stronger the capacity to suction the atmosphere becomes, but if the gap distance becomes 1 mm or less, the direction of the air current is reversed. In experiments hereafter, the gap distance was set at 3 mm.

FIG. 18 shows the width W, the depth of penetration D and D/W of the molten pool 210 at each gas flow rate; FIG. 19 shows oxygen concentration within the molten pool 210 at each gas flow rate; and FIGS. 20 to 24 show the molten pool 210 at 1 LM, 4 LM, 9 LM, 10 LM and 20 LM of the gas flow rate, respectively. As shown in FIG. 18 and FIGS. 20 to 24, the flow rate of Ar gas is at 1 LM to 9 LM, and it becomes ascertained that it is possible to deepen the depth of penetration D of the molten pool 210 within the range of 4 LM to 9 LM. According to FIG. 19, it becomes ascertained that the oxygen concentration in the molten pool 210 is decreased as the gas flow rate is increased. It [also] becomes ascertained that the oxygen concentration of the molten pool 210 enabling to deepen the depth of penetration D of the molten pool 210 is 70 ppm to 300 ppm, and 70 ppm to 160 ppm. Further, in the tungsten electrode 22 after welding with 80 mm of bead length, obvious wear was not confirmed before and after welding.

The welding nozzle 100a shown in FIG. 3 and FIG. 4 was mounted to the sleeve 20 of the torch 10 shown in FIG. 1 and FIG. 2, and the iron material 200 was welded. TIG welding was conducted in two layers of single pass welding from both sides under conditions of 180 A of a welding current, 3 mm of arc length, 8 LM of a flow rate of Ar gas, 1 mm/s of a welding rate and 3 mm of gap distance, and welded parts were cut to tension test specimens and a tension test was conducted. As shown in FIG. 25, the tensile strength of the welded part was 742 MPa while the tensile strength of a parent material is 787 Mpa, and it becomes ascertained that excellent tensile strength exceeding 520 MPa, which is a standard value, is obtained.

According to the arc welding method, the nozzle for arc welding and the arc welding device of one embodiment of the present invention, it becomes possible to introduce oxygen into a molten pool with a simpler technique, to further deepen the depth of penetration of the molten pool, and to enhance a weld efficiency.
10 torch
12 handle
14 connection
16 torch body
18 gas inlet part
20 sleeve
22 tungsten electrode
50 servo mechanism
62 photoelectric sensor
64 temperature sensor
70 control part
71D/W detecting part
72 gap control part
100a to 100d welding nozzle
102 nozzle inner cylinder
104 nozzle outer cylinder
105 screw thread
106 connecting wing
108 atmosphere introduction hole part
110 variable nozzle
112 nozzle piece
113 hinge
114 nut
115 screw thread
116 nut concave part
117 coil spring
118 slope
119 nozzle piece convex part
120 nozzle outer cylinder
128 atmosphere introduction hole part
130 nozzle inner cylinder convex part
131 nozzle outer cylinder concave part
200 iron material
210 molten pool
210c molten pool center part
210e molten pool end portion

1. A welding method, comprising:
an inert gas supply step to supply inert gas to a surface of a metallic material from the inside of a cylinder welding nozzle;
a heating step to heat the surface of the metallic material where the inert gas has been supplied by the welding nozzle in the inert gas supply step; and
an oxygen introduction step to introduce oxygen in atmosphere that has been suctioned due to a reduction of pressure generated in association with a flow of the inert gas in the inert gas supply step to a molten pool generated on the surface the metallic material in the heating step.

2. The welding method according to claim 1, wherein
the welding nozzle comprises:
a nozzle inner cylinder where the inert gas is distributed inside, and
a nozzle outer cylinder where atmosphere that has been suctioned due to a reduction of pressure generated in association with a flow of the inert gas that is distributed within the nozzle inner cylinder is distributed to a gap with the nozzle inner cylinder while surrounding a side of the nozzle inner cylinder;
in the inert gas supply step, the inert gas is supplied to the metallic material from the inside of the nozzle inner cylinder; and
in the oxygen introduction step, while the atmosphere that has been suctioned due to a reduction of pressure generated in association with the flow of the inert gas that is distributed within the nozzle inner cylinder is distributed in the gap between the nozzle inner cylinder and the nozzle outer cylinder.

3. The welding method according to claim 2, wherein
the welding nozzle comprises a gap variable unit that can adjust size of the gap between the nozzle inner cylinder and the nozzle outer cylinder; and
in the oxygen introduction step, an amount of atmosphere that is distributed to the gap between the nozzle inner cylinder and the nozzle outer cylinder is controlled by adjusting the size of the gap between the nozzle inner cylinder and the nozzle outer cylinder with the gap variable unit.

4. The welding method according to claim 2, wherein
the size of the gap between the nozzle inner cylinder and the nozzle outer cylinder is greater than 1 mm but 5 mm or less.

5. The welding method according to claim 1, wherein
the welding nozzle comprises an atmosphere introduction hole part that leads to the inside of the welding nozzle from the outside of the welding nozzle, and where the atmosphere that has been suctioned due to a reduction of pressure generated in association with a flow of the inert gas that is distributed within the welding nozzle is distributed; and
in the oxygen introduction step, while the atmosphere that has been suctioned due to a reduction of pressure generated in association with a flow of the inert gas that is distributed within the welding nozzle is distributed to the atmosphere introduction hole part, oxygen in the atmosphere is introduced into the molten pool.

6. The welding method according to claim 5, wherein
the welding nozzle comprises an introduction hole variable unit that can adjust the size of the atmosphere introduction hole part, and
in the oxygen introduction step, the amount of the atmosphere that is distributed in the atmosphere introduction hole part is controlled by adjusting the size of the atmosphere introduction hole part with the introduction hole variable unit, and the amount of oxygen to be introduced into the molten pool is controlled.

7. The welding method according to claim 1, wherein
in the oxygen introduction step, oxygen in the atmosphere is introduced into the molten pool so as to allow the amount of oxygen in the molten pool to be 70 ppm to 300 ppm.

8. The welding method according to claim 1, wherein
in the inert gas supply step, the inert gas is supplied by adjusting a flow rate of the inert gas at 1 LM to 9 LM.

9. A welding nozzle that supplies inert gas to a surface of a metallic material from an inside of a cylindrical welding nozzle, and that is used for welding that heats the surface of the metallic material where the inert gas has been supplied by the welding nozzle, comprising:
a nozzle inner cylinder where the inert gas is distributed inside, and
a nozzle outer cylinder where the atmosphere that has been suctioned due to a reduction of pressure generated in association with a flow of the inert gas that is distributed in the nozzle inner cylinder is distributed in a gap with the nozzle inner cylinder while surrounding the side of the nozzle inner cylinder, wherein
oxygen in the atmosphere is introduced into a molten pool generated on the surface of the metallic material due to heating by distributing the atmosphere that has been suctioned due to a reduction of pressure generated in association with a flow of the inert gas that is distributed in the nozzle inner cylinder to a gap between the nozzle inner cylinder and the nozzle outer cylinder.

10. The welding nozzle according to claim 9, comprising: a gap variable unit that can adjust the size of the gap between the nozzle inner cylinder and the nozzle outer cylinder, wherein
the amount of the atmosphere that is distributed to the gap between the nozzle inner cylinder and the nozzle outer cylinder by adjusting the size of the gap between the nozzle inner cylinder and the nozzle outer cylinder with the gap variable unit, and
the amount of oxygen to be introduced into the molten pool is controlled.

11. A welding nozzle that supplies inert gas to a surface of a metallic material from the inside of a cylindrical welding nozzle, and that is used for welding that heats the surface of the metallic material where the inert gas has been supplied by the welding nozzle, comprising:
atmosphere introduction hole parts that lead to the inside of the welding nozzle from the outside of the welding nozzle, and where the atmosphere that has been suctioned due to a reduction of pressure generated in association with a flow of the inert gas that is distributed within the welding nozzle is distributed, wherein
oxygen in the atmosphere is introduced into a molten pool generated on the surface of the metallic material due to the heating by distributing the atmosphere that has been suctioned due to a reduction of pressure generated in association with a flow of the inert gas that is distributed in the nozzle inner cylinder in a gap between the nozzle inner cylinder and the nozzle outer cylinder is introduced into the atmosphere introduction hole parts.

12. The welding nozzle according to claim 11, comprising an introduction hole variable unit that can adjust the size of the atmosphere introduction hole part, wherein
the amount of the atmosphere that is distributed in the atmosphere introduction hole part is controlled by adjusting the size of the atmosphere introduction hole parts by the introduction hole variable unit, and
the amount of oxygen to be introduced into the molten pool is controlled.

13. Welding equipment, comprising:
the welding nozzle according to claim 10,
a heat source that heats the surface of the metallic material where the inert gas has been supplied by the welding nozzle,
a molten pool monitoring unit that monitors the molten pool, and
an oxygen introduction amount control unit that controls an amount of oxygen to be introduced into the molten pool by the gap variable unit of the welding nozzle.

14. Welding equipment, comprising:
the welding nozzle according to claim 12,
a heat source that heats the surface of the metallic material where the inert gas has been supplied by the welding nozzle,
a molten pool monitoring unit that monitors the molten pool, and
an oxygen introduction amount control unit that controls an amount of oxygen to be introduced into the molten pool by the introduction hole variable unit of the welding nozzle, based upon a state of the molten unit monitored by the molten pool monitoring unit.
